(19) United States
(12) Patent Application Publication
(10) Pub. No.: US 2014/0359725 A1
(43) Pub. Date: Dec. 4, 2014

(54) System and Method for Providing Authentication and Authorisation for a Person to Perform Specific Instructions (Tasks)

(71) Applicant: Mark Rodney Anson, Ewingsdale (AU)

(72) Inventor: Mark Rodney Anson, Ewingsdale (AU)

(21) Appl. No.: 14/296,136

(22) Filed: Jun. 4, 2014

Related U.S. Application Data
(60) Provisional application No. 61/835,561, filed on Jun. 15, 2013.

(30) Foreign Application Priority Data
Jun. 4, 2013 (AU) 2013902014
Jun. 4, 2013 (AU) 2013902015

(51) Int. Cl. G06F 21/31; G06F 21/32; G10L 15/22

(52) U.S. Cl. CPC G06F 21/31; G10L 15/22; G06F 21/32
USPC 726/5

(57) ABSTRACT

An electronic system comprising: means for authenticating a task using a password entered into the system, by displaying, in an irregular manner, a plurality of symbols used to enter the password, where the symbols appear on an electronic screen of a device connected to the system.

### CROSS-REFERENCE TO RELATED APPLICATIONS

This application claims priority to Australian patent application no. 2013902014 entitled, “A System for Providing Authentication and Authorisation for a Person to Perform Specific Instructions (Tasks)”, and filed 4 Jun. 2013, Australian patent application no. 2013902015 entitled, “A Login Process for Mobile Phones, Tablets and Other Types of Touch Screen Devices” and filed on 4 Jun. 2013; and U.S. provisional patent application No. 61/835,561 entitled, “A System for Providing Authentication and Authorisation for a Person to Perform Specific Instructions (Tasks)” and filed on 15 Jun. 2013; each of which is hereby incorporated by reference as though fully set forth herein.

### BACKGROUND OF INVENTION

1. Technical Field

The present invention pertains to the field of portable communication devices including mobile phones.

2. Background Art

Portable communication devices including mobile phones have a long history. However, despite improvements in technology, security remains an ongoing concern.

### SUMMARY OF INVENTION

General problems with the background art, as identified by the inventor, include: limited use of biometric authentication in mobile communication technology.

Specific problems with the background art, as identified by the inventor, include: the failure to routinely include biometric authentication in the issuing of instructions (tasks to be undertaken) over an electronic communications network and in particular, absence of routine use of a camera installed on a mobile phone to ensure that instructions issued to a second person by a first person, are issued in a secure manner.

### Technical Problem

To ameliorate some of the effects of the general problems and the specific problems as recited above and in particular to provide, at least in part, a method for the secure issuing of instructions (authorised tasks) to a second person by a first person.

### Technical Solution

Central to the inventor's discovery is the realization that biometric authentication of the issuing of a task, by the use of software associated with a communication device, can prevent the issuance of fraudulent or unauthorized instructions. In particular, use of a camera installed in a communication device, including a mobile phone, for purposes of biometric authentication of an instruction (authorised task) can be an effective means for deterring the issuing of fraudulent instructions, particularly if an unauthorised person's facial details can be captured and passed on to law enforcement authorities by a camera installed on a communications device.

### Advantageous Effects

Advantageous effects include:

The reluctance of an unauthorised person to falsely issue instructions (tasks) or to falsely claim to be a person for whom the instructions are intended, if the person's face is capture by a camera installed on a communications device (the facial image then potentially being subjected to automated facial recognition checks by computer software located on a computer readable medium or by visual inspection by a person at a Digital Identity Management Service (DIMS)).

In view of the above, the invention provides an electronic system including means for authenticating a task using a password entered into the system, by displaying, in an irregular manner, a plurality of symbols used to enter the password, where the symbols appear on an electronic screen of a device connected to the system

### BRIEF DESCRIPTION OF DRAWINGS

FIG. 1 shows a user interface of a communications device according to one embodiment of the present invention.

FIG. 2 shows, according to one embodiment, components of the present system in use.

### DETAILED DESCRIPTION

### Best Mode

### Definitions and Terms

The description in the body of the specification pertains to “preferred” modes of invention. Accordingly, features recited in the body of the specification should not be construed to be essential features of the invention unless explicitly indicated. Further, any reference in the body of the specification to the expression “invention” should be construed to imply a reference to preferred embodiments only.

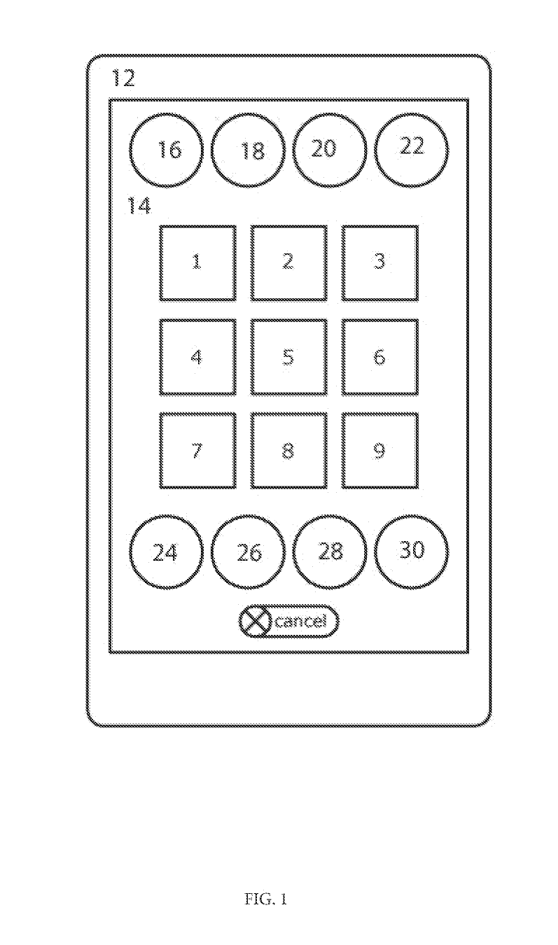

FIG. 1 shows, according to one embodiment, a user interface 14 of a mobile device 12. Displayed on the user interface 14, the user can see a keypad with numbers (1,2,3,4,5,6,7,8,9) and areas of different colours (16,18,20,22,24,26,28,30). Item 16 can be red and item 18 can be blue in one embodiment.

FIG. 1 discloses an embodiment of the present invention that can be used in a swipe login system in association with a Digital Identity Management Service (DIMS). This interface and associated processes are adapted for use on smartphones and other devices with touchscreens that can recognize “swipe” or “drag and drop” movements. However, people with desktop computers and laptops can also use this system.

Using a desktop or laptop computer, a person can simply click on elements in the grid in a sequence that can include 16, 8, 7, 18 to denote the entry code “Red, 8, 7, Blue”. To explain this, refer to FIG. 1, which depicts a login screen with a number of objects including boxes and circles that are displayed to a person logging in. The swipe configuration displayed in FIG. 1 could be used on the display screen of a first person's phone (who issues instructions) as part of a process in which the DIMS validates instructions issued by the first person to a second person. Alternatively a second person (who has been issued tasks by a first person) can use the login system as seen in FIG. 1 to validate their identity and to download instructions (tasks) from an electronic communication system.

Referring again to FIG. 1. In the case of a touchscreen device, the person logging in can touch the circular object marked 16, which denotes the colour red and then drag their finger on the touchscreen onto the square box 8 denoting the numeral “8”. This box 8 can then glow for an instant to advise the user of his\her action. The user can then touch the square box 7, which denotes the number 7 and then drag their finger across the touchscreen to the circular object 18 which can denote the colour blue. Within the circle 18 the number “7” can appear for a moment (to confirm the colour\number link). This completes the user action sequence. The input data of the user associated with objects displayed at positions “Red”, “8”, “7”, “Blue” can then be processed by a computer system and the system can then determine whether a person issuing an instruction (a first person) or a person receiving an instruction (a second person), have, in association with biometric validation, been properly authenticated to respectively issue or undertake tasks.

### Mode of Invention

The mode of invention as illustrated in FIG. 1 is adapted for use with mobile phones, laptop computers, desktop computers, tablets and a plurality of other communication devices (portable and non-portable). However, modes (embodiments) of invention can be contemplated in which the invention can be incorporated into a plurality of devices and systems including ATM banking machines, security gates and points of entry at highly secure locations including industrial plants and government facilities.

### INDUSTRIAL APPLICABILITY

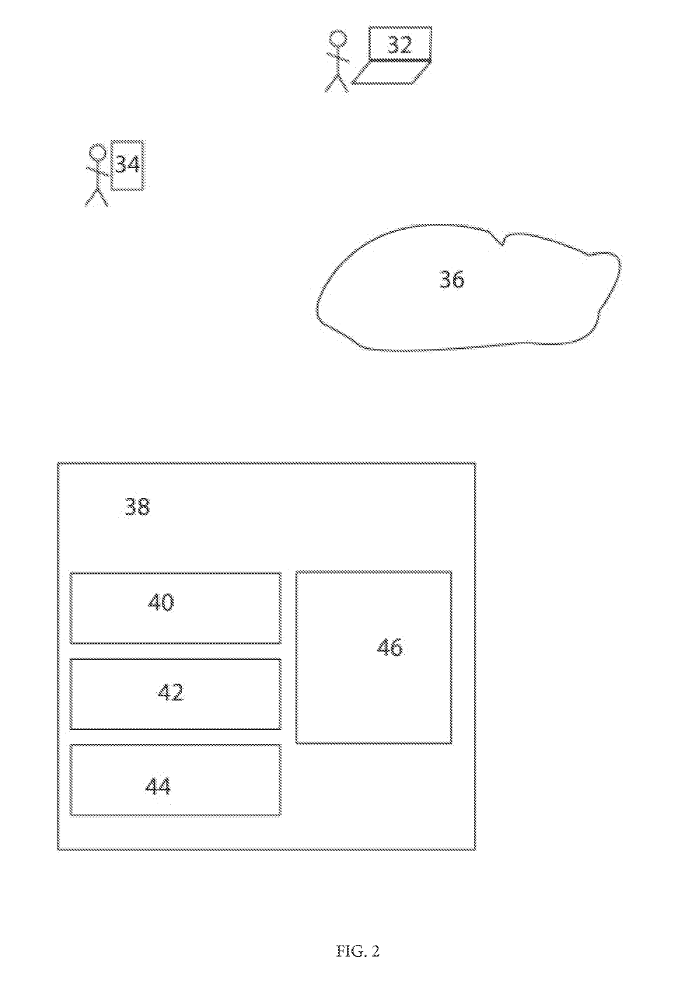

FIG. 2 illustrates use of a preferred mode of the present invention with a notebook computer 32, a mobile phone 34, a network 36 and a Digital Identity Management Service 38.

The DIMS 38 can include a database 46, executable software programs 40, a voice recognition component 42 and a biometric data analysis system 44.

FIG. 2, discloses a system in which a person with valid credentials recognized by a Digital Identity Management Service (DIMS) can use a smartphone, tablet, desktop computer, laptop computer or a similar device equipped with a front facing camera according to one preferred embodiment (cameras can face in a plurality of other directions in different embodiments) and a microphone to grant authorisation for another person to perform specific tasks. The tasks can include gaining access to a secure location, collecting and removing items from a secure location, receiving a cash payment at a secure location including an ATM machine, and checking in and boarding an aircraft, train, bus or other vehicle.

A person with trusted credentials hereafter known as the authorised person can provide authorisation to another person according to one embodiment of this system.

The authorising person can use a smartphone or similar device equipped with a front facing camera and microphone (for voice recognition purposes), together with a software application that can facilitate the completion of this process.

This software application, according to one embodiment, connects the first person to a Digital Identity Management Service (DIMS) that recognizes and authenticates the issuance of authority to a second person to perform an instruction (task) issued by the first person based upon the first person's credentials and other identifying indicia including, in one embodiment, assets that the first person issuing the instruction has control over. Assets controlled by the first person issuing an instruction (task) can include money in a bank account, vehicles, buildings and other types of assets sufficient to confirm the identity of the first person issuing instructions to the second person. The first person can launch a software application on the first person's smartphone or other device and begin a process of issuing instructions (tasks) to the second person.

To begin issuing an instruction (task), the first person can click a button displayed on the screen of the first person's mobile device that can display a message including “Authorise a Person” or words to that effect in English or other languages, or alternatively the first person can speak words into the microphone of the device and voice recognition software can translate spoken words into text and machine readable commands to then begin a process of issuing a task to the second person associated with a process of automated authentication of the validity of the instruction (task) by the Digital Identity Management Service (DIMS). In tasks deemed to carry exceedingly high levels of responsibility in which a “high security flag” has been triggered, additional auditing of the process of task authentication could mandate manual intervention and interrogation of a user by a physical person at the DIMS.

In one embodiment, a request to initiate an instruction (task) is sent from the phone of the first person to the Digital Identity Management Service (DIMS). When the DIMS receives the request to issue the instruction from the first person to the second person, the DIMS can send a response back to the first person seeking confirmation as to the first person's identity. This response can take the form of information displayed on the screen of the mobile phone of the first person, or alternatively spoken instructions can, in another embodiment, be heard from the speaker of the first person's phone.

The capacity of embodiments of the present invention for interaction between a first person and an installed software application, according to one embodiment, to be through voice communication provides an accessibility feature of this system for persons with disabilities, and also enables the system to be used by people using any language.

In one embodiment, the first person issuing a task can be requested to choose a second person that they wish to authorise to complete a task where the second person can be chosen from a list of contacts viewed on the screen of the device of the first person issuing the task. Alternatively, the name of the second person selected to execute the task can be spoken by the first person issuing the task and associated input can be converted into text data that is analysed by software downloaded from the DIMS onto the phone of the first person so that the right (authenticated) second person can be identified by the DIMS and given their instructions (tasks) to perform. Voice instructions by a user can in preferred embodiments be subject to confirmation by a user to avoid voice to text translation errors.

Additionally, the first person can instruct an organization or business to perform a specific task and that organization can further delegate and authorise a specific individual to become an authenticated second person who can complete the required task by acting as a representative or agent of the organization that has been approved (authenticated) by the DIMS for purposes of task execution. In a case where the first person issues instructions for an organization to perform tasks, the organization can have individuals who are appropriately credentialed to act on behalf of the organization to undertake the tasks.

The first person issuing an instruction can enter information into the system, according to one embodiment, detailing the specific task or tasks that the first person instructs the second person to perform (subject to authentication by the DIMS).

Detailing of tasks can be achieved by a variety of processes including speaking a set of instructions, typing detailed instructions via a keypad or keyboard, attaching a document outlining details of the tasks to be performed or entering details by a combination of voice and typed instructions so that an authorised person can be given a task.

There are a large number of tasks that can be advantageously carried out using this method. These tasks can include: instructing couriers to be given packages and documents; instructing a person to be given car keys and a car; instructing a person to enter a secure area within a building or another location; instructing or permitting a person to board an aircraft, bus, train or other vehicle and instructing a person to act as an agent of the first person in a specific situation or on an ongoing basis.

The process of assigning tasks completes the first step in the process for issuing instructions. After issuing the instructions, the first person (issuer) can revoke an instruction that has been issued to a person by launching a software application on their smartphone and by either using a touchpad or mouse, clicking to select the task or person from within lists of issued tasks or people and then clicking the “revoke” option attached to that task or person. Alternatively, according to one embodiment, the first person issuing instructions to the second person can launch a software application and speak instructions into a microphone on a phone. The instructions can then be transmitted to the DIMS, which can then initiate an electronic signal (propagated signal) to terminate (revoke) an instruction.

When a second person is instructed by a first person to perform a task or tasks, the second person can login to the communications system and communicate with the DIMS using the software application provided by the DIMS. The second person (who has been instructed and authenticated to perform a task) can then see details of the task that the second person has been instructed to perform. This listing of tasks seen by a second person authenticated to perform tasks can be implemented in many ways. In particular, the DIMS can create a secure access code for each task or series of tasks the second person is given, for example the secure access code “Red 8 7 Blue” can comprise one access code so that when the second person, who is instructed to perform tasks for the first person, goes to complete that task then the second person can use the secure access code “Red 8 7 Blue” in order to be authenticated by the DIMS for task execution purposes.

When a second person (instructed to perform tasks for a first person) presents himself\herself at a secure location that he\she could have been granted permission to enter, the second person can then check in at that location using a secure access code. This check in process could involve the second person speaking his\her name or typing his\her name, or using some other way of announcing his\her arrival at that location including announcing himself\herself to staff who control site access at the location or by entering a secure access code.

Accordingly, when an authorised person checks in, they could be further required to provide a secure access code before they can proceed further into a secure location (as well as biometric authentication). As recited above, one preferred method of check in could be for the authorised person to use a touchscreen device to enter their secure access code. This requirement could be dispensed with in some scenarios, but this requirement could be highly advantageous in one preferred embodiment.

In one embodiment of this system of providing instructions and authenticating a person to execute instructions using the DIMS, a second person could be issued with an instruction to perform hazardous operations at a chemical engineering plant (operations that could result in severe property damage and personal injury if not undertaken by a properly credentialed person). Accordingly, the login system in FIG. 1 can be used by the first person (together with biometric authentication by a camera and validation by the DIMS) to initiate and validate instructions. Further, as previously recited, the instructions upon being authenticated by the DIMS can then be cleared for issuance to the second person and the second person upon entering their own login sequence using the login configuration illustrated in FIG. 1, can, after having also been biometrically authenticated using a camera, then be cleared to enter a hazardous area of the engineering plant to undertake a task.

Following completion of the tasks that are to be executed by the second person, the Digital Identity Management Service (DIMS) can automatically receive an update that the task has been completed from devices that the second person has used to check in. There are a range of situations where this system can be used, and in different situations, the feedback given by a check in device to the Digital Identity Management Service (DIMS) can occur in different ways.

In use, further procedures can also be implemented to authenticate issuing of a task, including the use of identifying indicia for a communication device such as a phone's IMEI number.

As a further check, the mobile communication device's location (that can be found by a plurality of methods including triangulation and GPS tracking) can be used to provide an added level of security in the context of embodiments of the present invention.

In use, the methods and systems recited above can be further secured by using means comprising:

i) irregular password entry;

ii) swipe gestures for password entry purposes;

iii) randomizing displays for password entry purposes;

iv) setting a minimal password entry length;

v) using a device's location in order to authenticate a task;

vi) using a device's identifying indicia in order to authenticate the task;

vii) using biometric authentication including voice and facial recognition, in order to authenticate the task.

### RESERVATIONS

Copyright in drawings the subject of this application is reserved and remains the property of NOWWW.US Pty Ltd ACN 137 333 709 and its assigns.

What is claimed is:

1. An electronic system comprising: means for authenticating a task using a password entered into the system, by displaying, in an irregular manner, a plurality of symbols used to enter the password, where the symbols appear on an electronic screen of a device connected to the system.

2. The system as recited in claim 1, further comprising means for moving a first one of the symbols towards a second one of the symbols in order to enter the password.

3. The system as recited in claim 2, further comprising means for entering the password using a swipe gesture.

4. The system as recited in claim 3, further comprising means for randomizing the symbols.

5. The system as recited in claim 4, further comprising means for using the device's location in order to authenticate the task.

6. The system as recited in claim 5, further comprising means for ensuring that the password is of at least a predetermined length.

7. The system as recited in claim 6, further comprising means for using the device's identifying indicia, in order to authenticate the task.

8. The system as recited in claim 7, further comprising means for using biometric authentication in order to authenticate the task.

9. The system as recited in claim 8, further comprising means for using facial recognition, in order to authenticate the task.

10. The system as recited in claim 9, further comprising means for using voice recognition, in order to authenticate the task.
